(19) United States
(12) Patent Application Publication
(10) Pub. No.: US 2011/0233946 A1
(43) Pub. Date: Sep. 29, 2011

(54) CROSS MEMBER

(75) Inventors: MARKUS PELLMANN, Sassenberg (DE); Martin Pohl, Altenbeken (DE); Martin Schroeter, Paderborn (DE); Stefan Adelbert, Delbruck (DE); Otto Buschsieweke, Paderborn (DE); Christian Handing, Langenberg (DE)

(73) Assignee: Benteler Automobiltechnik GmbH, Paderborn (DE)

(21) Appl. No.: 13/069,510

(22) Filed: Mar. 23, 2011

(30) Foreign Application Priority Data
Mar. 25, 2010 (DE) 102010012825.2-21

(51) Int. Cl. B60R 19/26; B62D 21/03; B32B 5/14

(52) U.S. Cl. 293/132; 296/203.01; 428/610; 428/582; 428/603

(57) ABSTRACT

A cross member made of sheet steel has a first region which underwent heat treatment, a second region which is not heat-treated, and a transition zone between the first and second regions. The transition zone is hereby defined by a width which is smaller than or equal to 50 mm.

### CROSS-REFERENCES TO RELATED APPLICATIONS

This application claims the priority of German Patent Application, Serial No. 10 2010 012 825.2-21, filed Mar. 25, 2010, pursuant to 35 U.S.C. 119(a)-(d), the content of which is incorporated herein by reference in its entirety as if fully set forth herein.

This is one of five applications all filed on the same day. These applications deal with related inventions. They are commonly owned and have the same inventive entity. These applications are unique, but incorporate the others by reference. Accordingly, the following U.S. patent applications are hereby expressly incorporated by reference: “SIDE RAIL”, representative's docket no.: PELLMANN-3; “TRANSMISSION TUNNEL”, representative's docket no: PELLMANN-4″; “AUTOMOBILE COLUMN”, representative's docket no.: PELLMANN-5; and “METHOD FOR PRODUCING A MOTOR VEHICLE COMPONENT, AND A BODY COMPONENT”, representative's docket no.: PELLMANN-6.

### BACKGROUND OF THE INVENTION

The present invention relates to a cross member, and more particularly to a cross member for installation in a motor vehicle.

It would be desirable and advantageous to provide an improved cross member which obviates prior art shortcomings and can be produced at low cost in industrial-scale production while still being reliable in operation.

### SUMMARY OF THE INVENTION

According to one aspect of the present invention, a cross member is made of sheet steel and has a first region which underwent heat treatment, a second region which is not heat-treated, and a transition zone between the first and second regions, with the transition zone defined by a width which is smaller than or equal to 50 mm.

According to another advantageous feature of the present invention, the cross member can be produced by hot-forming and press-hardening of a steel sheet blank, with the first region undergoing heat treatment after press-hardening.

In accordance with the present invention, the material property in certain regions of the cross member can be produced with a reliable process and with desired properties. After hot-forming and press-hardening of a steel sheet blank made from high-strength hardenable steel, a particular area of the cross member is targeted to undergo a heat treatment. Heat-treating a particular area of a component, such as the cross member, will hereinafter also be referred to a “partially” heat-treating or “partial” heat treatment of a component or an area of a component. The heat treatment is carried out below the austenitic transition temperature, so that ductile material structures are produced in the heat-treated regions of the cross member.

A cross member according to the invention may be arranged in a motor vehicle body, for example transversely at the front and rear side, for intentionally stopping an impacting object or another motor vehicle. The cross member should stop the object impacting the motor vehicle or the stationary body hit by the motor vehicle so that the absorbed energy minimally deforms the cross member and an impacting object is prevented from intentionally entering the motor vehicle itself.

The cross member is hereby mostly coupled to the motor vehicle via crash boxes. The crash boxes are in turn attached to, for example, longitudinal beams disposed on the side of the motor vehicle. The hot-formed and press-hardened cross member according to the invention with regions that are partially heat-treated after press-hardening can be provided in its center region with high stiffness and strength, while simultaneously ensuring high ductility at the attachment points of the crash boxes. The high ductility in the receiving regions prevents the crash boxes coupled to the cross member from being torn off in the event of a crash and facilitates deformation so that kinetic energy from the impact can be intentionally converted into deformation energy. This significantly reduces the risk that the cross member is accidentally torn off in the event of a crash.

A cross member of a motor vehicle according to the invention is also, for example, a cross member in the floor assembly or in the roof assembly of the motor vehicle. A cross member integrated in the floor assembly may be, for example, a seat cross member. The seat cross member is used for receiving seat rails to which the vehicle seats are attached. It is hereby also of particular importance in the event of a crash that the coupling regions of the seat cross member with the floor assembly and also with the seat rails have high ductility, so that the seat rails are essentially prevented from being torn off or detached during a deformation of the floor assembly in the event of a crash.

Additionally, the partially heat-treated regions attenuate vibrations which are transferred to the vehicle seat and therefore to the vehicle occupants from, for example, the road surface or the drive train. The cross member according to the invention in form of a seat cross member thus additionally stiffens the floor assembly of a motor vehicle while simultaneously addressing attenuation and safety-related aspects for attaching the vehicle seat.

With the cross member according to the invention, the energy absorption capability of the entire motor vehicle body is increased while maintaining high stiffness. In a motor vehicle equipped with the cross member according to the invention a large amount of energy is absorbed by converting kinetic energy from the impact into deformation energy while retaining a high stiffness of the passenger compartment.

Another advantage of the cross member of the invention is that those regions that remain intentionally unchanged after press-hardening prevent accidental buckling of the floor assembly. The high stiffness of the regions that are not heat-treated thus prevents an accidental deformation in certain regions.

According to another advantageous feature of the present invention, the width of the transition zone may be less than 30 mm, suitably less than 20 mm. Within the context of the present invention, the transition zone from a heat-treated region to a non-heat-treated region is comparable to a zone affected by heat from a weld seam. Moreover, the material structure is changed in the transition zone which is not necessarily desirable.

According to another advantageous feature of the present invention, the cross member may include a transition zone of less than 15 mm. Accordingly, those regions on the individual components, in particular on the cross member, which are designed to deform in the event of a crash and those regions which can essentially retain their shape in the event of a crash, can already be assigned during the manufacture of a crash-optimized motor vehicle body.

According to another advantageous feature of the present invention, the width of the heat-treated region may correspond to 0.2-times to 3.0-times the width and/or the height of the heat-treated region. In relation to the distribution of the total stress inside the component, a particularly advantageous embodiment for the crash and stiffness structure of the motor vehicle body is attained.

Advantageously, joining flanges may be partially heat-treated. The heat-treated region, in particular embodied as joining flange, is advantageous for the crash property and stiffness of the body, such as an exemplary integral body-frame body. As already described above, parts of the floor assembly, rocker panels, longitudinal beams, engine supports and various components for coupling the drive train can be arranged on the joining flanges of a cross member. The coupling can be produced by gluing, riveting, welding, brazing or similar coupling processes.

The region which has been partially heat-treated does not tend to tear or detach in the event of the accident and therefore holds the attached surrounding structural and safety components together. This is particular advantageous for the protection of occupants in a passenger compartment.

Another advantage relates to regions subjected to an intentional deformation in the event of an accident. The regions defined for targeted deformation can be deformed without cracking. This also increases the overall energy absorption capability of the entire motor vehicle body accompanied by a small incursion depth into the passenger compartment.

Advantageously, the hardened regions of the cross member which are intentionally left in place may also promote a high torsional stiffness of the motor vehicle body. For a seat cross member, these regions may be, for example, coupled with the transmission tunnel and thereby further increase the torsional stiffness of a motor vehicle body or transmission of high drive forces of a drive train extending, for example, through the transmission tunnel. Another advantage in conjunction with the intentional partial heat treatment is that the intentionally softer heat-treated regions can attenuate to a certain extent vibrations transmitted to the vehicle seat, for example by stick-slip-behavior of a motor vehicle. This improves the driving comfort due to reduced vibrations of the vehicle seats.

Another application is, for example, the targeted deformation of individual regions to facilitate lower cost repairs after an accident. This deformation is intended to transfer energy to be dissipated into the body, thereby once more improving the safety for the vehicle occupants in the event of a crash.

The regions heat-treated with the method of the invention can be deformed in the event of a crash so as to produce intentional wrinkles accompanied by absorption of energy. Additionally, the heat-treated regions tend to form less cracks due to their ductile structure compared to the hot-formed and press-hardened, hard and brittle structure.

The partially heat treatment of joining flanges has the additional advantage that the joining flanges have ductile material properties. With a material connection produced by thermal joining, a structural change takes place in a subsequent process in the zone affected by heat generated by the joining method. A ductile section of the cross member is particularly advantageous for the welding process and the material structure created in the zone affected by heat of the welding process. This is particularly advantageous for the integrity of the connected weld seams of the motor vehicle in the event of an accident.

According to another advantageous feature of the present invention, openings in the cross member may be partially heat-treated. These openings may be incorporated in the component, for example, to reduce weight or for passing through other components, for example a wiring harness or an actuator for seat adjustment and the like. Cracks can form in an accident particularly in the region of the openings and also in the end region of openings due to stress in the components, in particular surface stress, which may extend over the entire component.

By reducing the surface stress, a ductile material structure is obtained in this region. This counters the formation of cracks and hence also an easier unintentional deformation of the cross member. Openings can be provided in a cross member arranged on the front or rear end of the motor vehicle to optimize weight.

A cross member constructed according to the concept of the invention may advantageously reduce stress in the end regions of the openings, so that the cross member can be prevented from buckling or breaking over a significant length transverse to the vehicle direction in the event of a crash. In this way, a weight-optimized cross member is provided which withstands more stringent crash requirements and has simultaneously a low weight and which can be manufactured from conventional hardenable steel.

According to another advantageous feature of the present invention, an end region of the cross member may be partially heat-treated, wherein a joining flange arranged on the end region is not heat-treated. This has the advantage that by incorporating the cross member in a motor vehicle body, the heat-treated regions can attenuate loads from reverse bending stresses, which may be introduced into the body by, for example, body torsion or other driving parameters, for example drive train vibrations and the like. This has a beneficial effect particularly with respect to the service life of the motor vehicle body by reducing the surface stress in the end regions, positively affecting the required crash properties of the joining flanges connected to the motor vehicle body that are not heat-treated.

According to another advantageous feature of the present invention, spot-shaped zones of the cross member may be partially heat-treated, wherein the spot-shaped zones have sizes of less than 50 mm. Currently preferred is a size of less than 30 mm. For connecting the cross member to a motor vehicle body, these spot-shaped zones may be advantageously intentionally heat-treated, thereby allowing spot welding or other local laser welding within the spot-shaped zones of a type frequently performed in the production of motor vehicles. In the event of a motor vehicle crash, the cross member with the coupled components has again high connection strength in these connected spot-shaped zones. Crack formation or tearing or disconnection is significantly reduced with the heat-treated spot-shaped zones.

Advantageously, the heat-treated regions may have a yield strength between 300 N/mm² and 1300 N/mm², suitably 400 N/mm² to 800 N/mm². Currently preferred is a yield strength of 400 N/mm² to 600 N/mm². In addition, the heat-treated regions may have advantageously a tensile strength between 400 N/mm² and 1600 N/mm², suitably 500 N/mm² to 1000 N/mm². Currently preferred is a tensile strength of 550 N/mm² to 800 N/mm², and advantageously a ductility between 10% and 20%, and currently preferred 14% to 20%. The material still has the required high-strength mechanical properties; however, due to the reduced tensile strength, elongation limit and the increased ductility the material is sufficiently ductile to produce wrinkles, instead of breaking or tearing, under a suitable load. This advantageously counters potential crack formation in the heat-treated region of the material.

According to another advantageous feature of the present invention, the yield strength and/or tensile strength may decrease in the transition zone from heat-treated region to non-heat-treated region with a gradient of more than 100 N/mm² per 1 cm, suitably more than 200 N/mm² per 1 cm. Currently preferred is a gradient of more than 400 N/mm² per 1 cm. Advantageously, very small local regions may be heat-treated, whereas the transition zones are kept smaller in relation thereto. The transition zone resulting from the gradient between the hot-formed and press-hardened, non-heat-treated region and the partially heat-treated region has a therefore a size of less than 50 mm, suitably between 1 mm and 20 mm. This produces small local heat-treated regions with sharp edges and smaller transition zones compared to the heat-treated regions.

According to another advantageous feature of the present invention, the cross member may be partially heat treated by heating the region to be heat-treated to a heat-up temperature, holding the heat-up temperature during a holding time, and cooling down from the heat-up temperature in at least two phases.

According to another advantageous feature of the present invention, the component may be heated up to and in held at the heat-up temperature in a temperature range between 500° C. and 900° C. The temperature range between 500° C. and 900° C. for heat-up and holding the heat-up temperature intentionally and reliably reduces stress in the heat-treated regions during production.

According to another advantageous feature of the present invention, heat-up may occur over a time period of up to 30 seconds, suitably of up to 20 seconds. Currently preferred is a time period of up to 10 seconds or of up to 5 seconds. The short heat-up phase for reaching the heat-up temperature is, in combination with a subsequent holding phase, particularly advantageous for the process reliability of the produced component.

According to another advantageous feature of the present invention, the holding time may extend over a time period of up to 30 seconds. Suitably, the holding time may extend over a time period of up to 20 seconds. Currently preferred is a time period of up to 10 seconds or of up to 5 seconds. Within the context of the invention, the hardening and tempering process can be particularly reliably performed by intentionally controlling the material structure transformation at a constant temperature and is only affected by the duration of the holding time. The attained heat-up temperature is held substantially constant.

According to another advantageous feature of the present invention, the first cooldown phase may have a longer duration than the second cooldown phase. This is particularly advantageous for the material structure to be produced and for the related processing steps. The cross member according to the invention can be post-processed immediately following processing. It is therefore feasible within the context of the invention that the heat-treated regions as well as the transmission tunnel have a component temperature of 200° C. when transferred to a post-processing process.

Moreover, the second phase may advantageously be performed in a time period of up to 120 seconds, suitably of up to 60 seconds.

According to another aspect of the present invention, a bumper arrangement for a motor vehicle includes a cross member including a cross member made of sheet steel and having a first region which underwent heat treatment, a second region which is not heat-treated, and a transition zone between the first and second regions, with the transition zone defined by a width which is smaller than or equal to 50 mm, and a crash box coupled to the cross member.

According to another advantageous feature of the present invention, a coupling region between the cross member and the crash box may have at least one area which can be heat-treated after coupling.

Advantageously, the bumper arrangement according to the invention has a particularly high hardness in the event of a crash due to the hot-formed and press-hardened cross member. The bumper arrangement according to the invention can also convert a large portion of the kinetic energy resulting from a vehicle crash into deformation energy. The narrow, partially heat-treated regions significantly reduce the risk of the coupling location being torn off or detaching from the cross member and crash box, without adversely affecting the stiffness of the cross member.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 shows a detail of a cross member according to the invention;

FIG. 2 shows a roof cross member according to the invention;

FIG. 3 shows a seat cross member according to the invention;

FIG. 4 shows a bumper arrangement according to the invention; and

FIGS. 5a), b), c) show different temperature curves during manufacture of the cross member.

### DETAILED DESCRIPTION OF PREFERRED EMBODIMENTS

Throughout all the figures, same or corresponding elements may generally be indicated by same reference numerals. These depicted embodiments are to be understood as illustrative of the invention and not as limiting in any way. It should also be understood that the figures are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

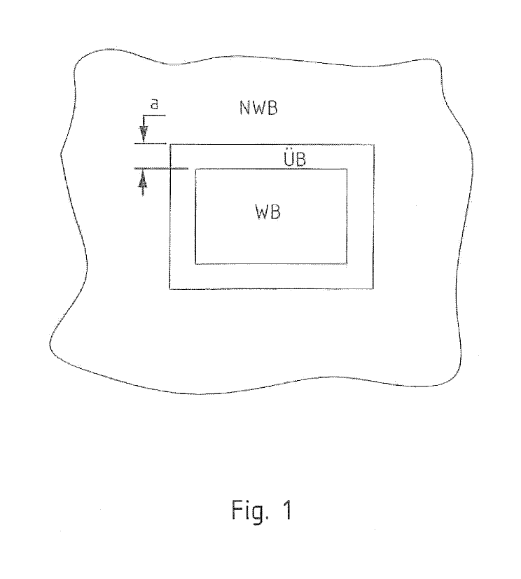

Turning now to the drawing, and in particular to FIG. 1, there is shown a detail of a cross member. As can be seen, a heat-treated region WB is according to the present invention formed in a non-heat-treated region NWB. A transition zone UB is disposed between the non-heat-treated region NWB and the heat-treated region WB. A material structure having the tendency to be ductile is created in the heat-treated region WB, whereas the material structure in the non-heat-treated region NWB is hard and brittle. The transition zone UB is inherently created during treatment of the heat-treated region WB. In the context of the present invention, the transition zone UB has essentially a width a, which extends from the heat-treated region WB to the non-heat-treated region NWB, which is particularly small in relation to the heat-treated region WB and which has substantially sharp edges.

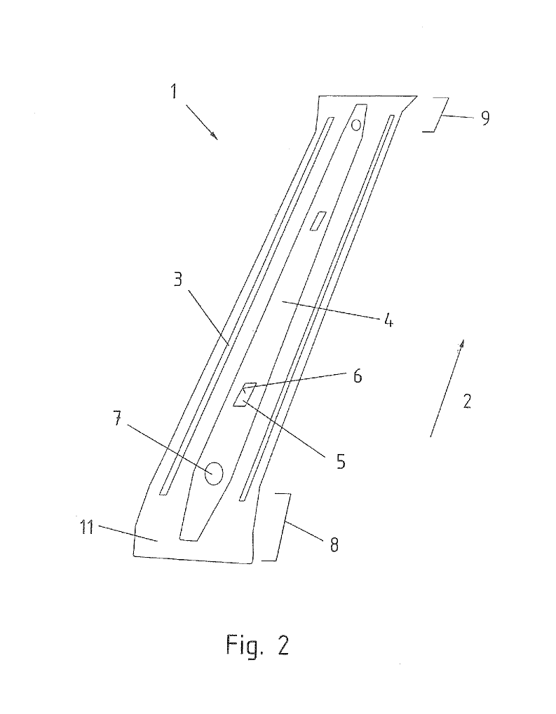

FIG. 2 shows a roof cross member 1 for installation on and coupling to an unillustrated vehicle roof. The roof cross member 1 has projections 4 and openings 5 as well as beads 3 aligned along its longitudinal direction 2. The marginal regions 6 of the openings 5 are partially heat-treated. The roof cross member 1 according to the invention has additional regions subjected to point-shaped heat treatment 7, which are used, for example, for coupling to an unillustrated vehicle roof by spot welding. The front end 8 and rear end 9 of the roof cross member 1 are also partially heat-treated to produce a connecting region, for example when arranged in an unillustrated B-column. The front end 8 and the rear end 9 can be formed, for example, as a joining flange 11. The partially heat treatment prevents in the event of a crash the roof cross member 1 from being torn off or becoming disconnected from the unillustrated coupled B-column. As a result, the passenger compartment has a high stiffness.

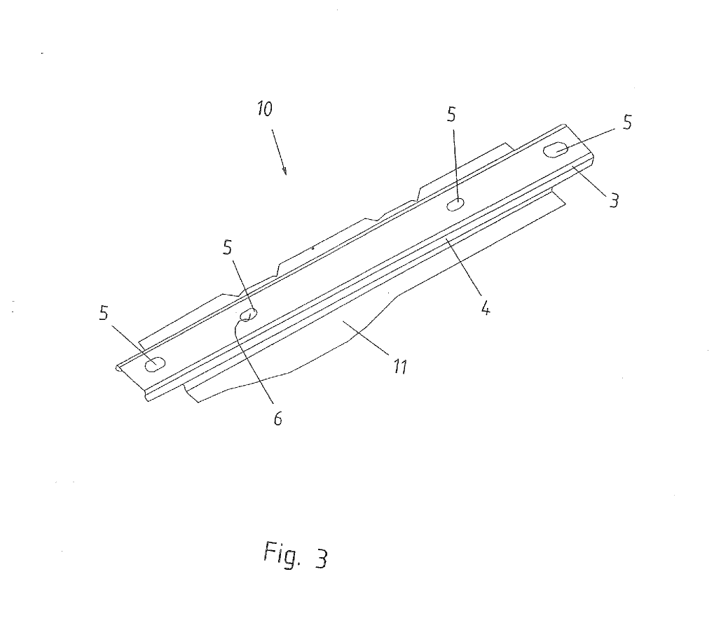

FIG. 3 shows a seat cross member 10, which likewise has beads 3, projections 4, openings 5 as well as joining flanges 11. The openings 5 mainly represent through-holes for attachment of unillustrated seat rails. However, individual components may also pass through the openings 5. For example, the unillustrated components may be a wiring harness or actuators for adjusting an unillustrated vehicle seat. According to the invention, the marginal regions 6 of the openings 5 are also heat-treated.

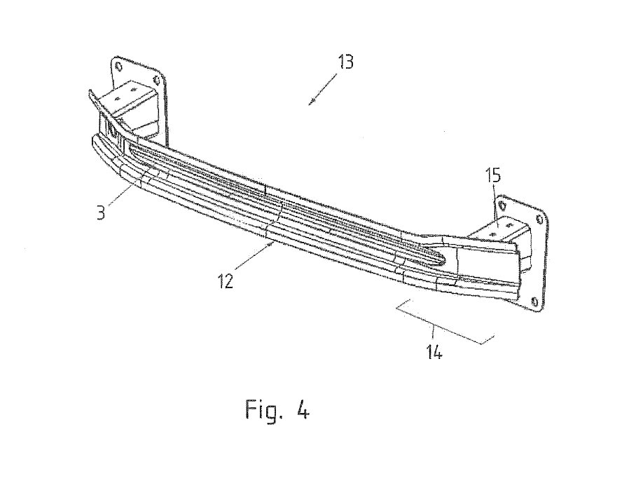

FIG. 4 shows a cross member 12 according to the invention for arrangement on the front side or rear side of an unillustrated motor vehicle. The illustrated embodiment of the cross member 12 shows a bumper arrangement 13 for a motor vehicle. The cross member 12 has at each of its end regions 14 a crash box 15 coupled to the cross member 12. The cross member 12 also includes beads 3, projections and openings.

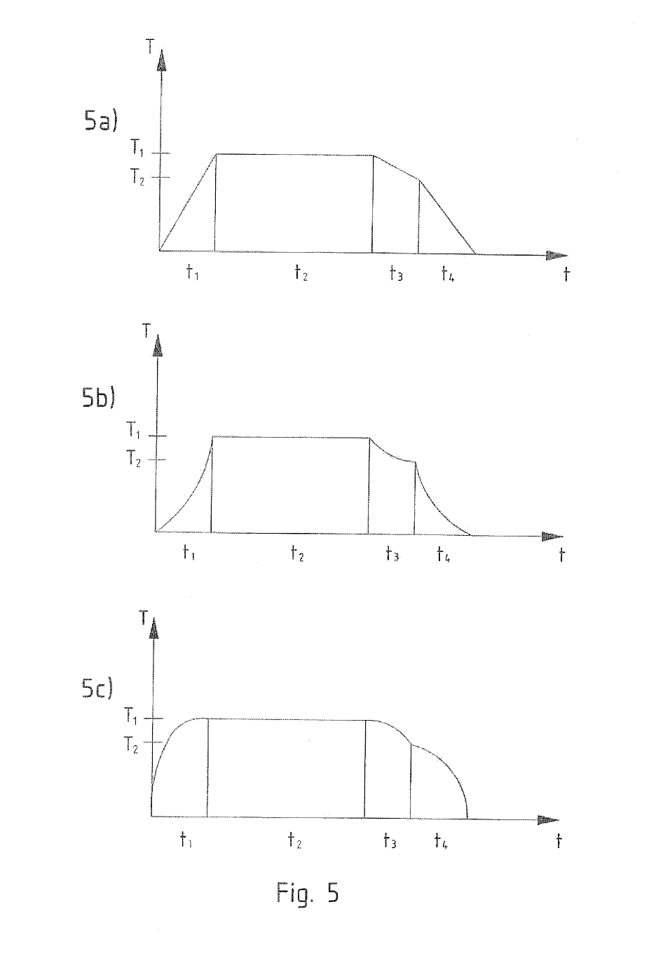

FIG. 5a shows a temperature curve as a function of time, with the time intervals heat-up time t1, holding time t2, cooldown time first phase t3 and cooldown time second phase t4. Also shown on the temperature axis are the heat-up temperature T1 and a first cooldown temperature.

Starting with a blank of sheet steel which is hot-formed and press-hardened to produce a cross member which is essentially at a temperature below 200° C., this vehicle component is heated during the heat-up time to the heat-up temperature T1. With a starting temperature of below 200° C., but still above room temperature, the residual thermal energy from the hot-forming and press-hardening process is used for the partial heat treatment within the context of the invention.

Heat-up includes a linear temperature increase as a function of time. After the heat-up time t1, the heat-up temperature T1 is maintained during a holding time t2. The heat-up temperature T1 is held essentially constant during the entire holding time t2. Temperature variations in form of a temperature increase or a temperature decrease are not illustrated, but may be implemented within the context of the invention during the holding time t2 to affect the desired changes in the material structure, but also for cost reasons of the production process.

At the end of the holding time t2, a first cooldown to a cooldown temperature occurs. The temperature hereby decreases linearly during the cooldown time of the first phase t3 to the cooldown temperature. The cooldown temperature may be in a range between 100° C. and a heat-up temperature.

In an immediately following second cooldown phase, an additional linear temperature decrease takes place during the cooldown time of the second phase t4. The temperature can hereby essentially be lowered to room temperature or to a desired (unillustrated) target temperature. It would also be feasible within the context of the invention to include additional cooldown phases, which are not illustrated.

FIG. 5b shows a substantially similar temporal arrangement of the heat treatment, with the difference to FIG. 5a that the temperature increases progressively during the heat-up time t1, whereas the temperature steadily decreases with time during the first and second phase of the cooldown.

FIG. 5c shows, in addition to FIGS. 5a and 5b, that the temperature curve has a diminishing temperature increase during the heat-up time t1 and that the functional dependence of the temperature decrease over time is progressive during each of the various cooldown phases.

In the context of the invention, it would also be feasible to combine the temperature dependence over time in mixed forms, such as progressive, linear and diminishing, and to realize a temperature change with progressive, diminishing or linear functional dependence during the holding time.

While the invention has been illustrated and described in connection with currently preferred embodiments shown and described in detail, it is not intended to be limited to the details shown since various modifications and structural changes may be made without departing in any way from the spirit and scope of the present invention. The embodiments were chosen and described in order to explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. A cross member made of sheet steel, said cross member having a first region which underwent heat treatment, a second region which is not heat-treated, and a transition zone between the first and second regions, said transition zone defined by a width which is smaller than or equal to 50 mm.

2. The cross member of claim 1 for installation in a motor vehicle body.

3. The cross member of claim 1, said cross member produced by hot-forming and press-hardening of a steel sheet blank, said first region undergoing heat treatment after press-hardening.

4. The cross member of claim 1, wherein the width of the transition zone is less than 30 mm.

5. The cross member of claim 1, wherein the width of the transition zone is less than 20 mm.

6. The cross member of claim 1, wherein the width of the transition zone corresponds to 0.2 times to 3.0 times a width and/or height of the first region.

7. The cross member of claim 1, said cross member having joining flanges having at least one region which is heat-treated.

8. The cross member of claim 1, said cross member having openings having at least one area which is heat-treated.

9. The cross member of claim 1, said cross member having recesses having at least one area which is heat-treated.

10. The cross member of claim 1, wherein the first region of the cross member is an end region, said cross member having a joining flange arranged on the end region and constituting the second region.

11. The cross member of claim 1, wherein the first region has spot-shaped zones defined by a size which is less than 50 mm.

12. The cross member of claim 1, wherein the first region has spot-shaped zones defined by a size which is less than 30 mm.

13. The cross member of claim 1, wherein the first region is defined by a yield strength between 300 N/mm² and 1300 N/mm².

14. The cross member of claim 1, wherein the first region is defined by a yield strength from 400 N/mm² to 800 N/mm².

15. The cross member of claim 1, wherein the first region is defined by a yield strength from 400 N/mm² to 600 N/mm².

16. The cross member of claim 1, wherein the first region is defined by a tensile strength between 400 N/mm² and 1600 N/mm².

17. The cross member of claim 1, wherein the first region is defined by a tensile strength from 500 N/mm² to 1000 N/mm².

18. The cross member of claim 1, wherein the first region is defined by a tensile strength from 550 N/mm² to 800 N/mm².

19. The cross member of claim 1, wherein the first region is defined by a ductility between 10% and 20%.

20. The cross member of claim 1, wherein the first region is defined by a ductility from 14% to 20%.

21. The cross member of claim 1, wherein the transition zone is defined by a yield strength and/or tensile strength decreasing with a gradient of more than 100 N/mm² per 1 cm.

22. The cross member of claim 1, wherein the transition zone is defined by a yield strength and/or tensile strength decreasing with a gradient of more than 200 N/mm² per 1 cm.

23. The cross member of claim 1, wherein the transition zone is defined by a yield strength and/or tensile strength decreasing with a gradient of more than 400 N/mm² per 1 cm.

24. The cross member of claim 3, wherein the heat treatment of the first region includes heating to a heat-up temperature, holding the heat-up temperature during a holding time, and cooling down from the heat-up temperature in at least two phases.

25. The cross member of claim 24, wherein the heat-up temperature ranges between 500° C. and 900° C.

26. The cross member of claim 24, wherein the first region is heated to the heat-up temperature at a time interval of up to 30 seconds.

27. The cross member of claim 24, wherein the first region is heated to the heat-up temperature at a time interval of up to 20 seconds.

28. The cross member of claim 24, wherein the first region is heated to the heat-up temperature at a time interval of up to 10 seconds.

29. The cross member of claim 24, wherein the first region is heated to the heat-up temperature at a time interval of up to 5 seconds.

30. The cross member of claim 24, wherein the holding time is up to 30 seconds.

31. The cross member of claim 24, wherein the holding time is up to 20 seconds.

32. The cross member of claim 24, wherein the holding time is up to 10 seconds.

33. The cross member of claim 24, wherein the holding time is up to 5 seconds.

34. The cross member of claim 24, wherein a first phase of the two cooldown phases has a duration which is longer than a duration of a second phase of the two cooldown phases.

35. The cross member of claim 34, wherein the duration of the second phase is up to 120 seconds.

36. The cross member of claim 34, wherein the duration of the second phase is up to 60 seconds.

37. A bumper arrangement for a motor vehicle, comprising:
a cross member made of sheet steel, said cross member having a first region which underwent heat treatment, a second region which is not heat-treated, and a transition zone between the first and second regions, said transition zone defined by a width which is smaller than or equal to 50 mm; and
a crash box coupled to the cross member.

38. The bumper arrangement of claim 37, wherein a coupling region between the cross member and the crash box has at least one area which is heat-treated after coupling.
